(19) United States
(12) Patent Application Publication
(10) Pub. No.: US 2012/0281798 A1
(43) Pub. Date: Nov. 8, 2012

(54) Solid-state pulsed power plasma jet injector

(76) Inventors: John Robert Thompson, San Diego, CA (US); Ioan-Niculae Bogatu, San Diego, CA (US)

(21) Appl. No.: 13/068,191

(22) Filed: May 4, 2011

(51) Int. Cl. H05H 1/10; H05H 3/06

(52) U.S. Cl. 376/114; 376/121; 376/127

(57) ABSTRACT

A method and apparatus for rapidly producing a plasma jet on demand. A particular application is the production of such a jet and its injection into a magnetically confined target plasma for the purpose of mitigating an emerging disruption event. The apparatus includes a gas source cartridge having concentric inner and outer electrically nonconductive containment tubes, which contain a solid mixture of titanium hydride and fullerene in the annular cylindrical volume between them. The mixture is resistively heated by application of a high power electrical current to produce a gaseous mixture of hydrogen and fullerene within a few tens of microseconds. The resulting mixture of hydrogen and fullerene is introduced radially into an accelerator tube passing through the gas cartridge, where the gas mixture is ionized, accelerated and injected as a plasma jet into the target plasma.

### BACKGROUND OF THE INVENTION

The present invention is generally related to methods and apparatuses for rapidly producing and ionizing a gaseous mixture on demand to form a plasma. In particular, the present invention is related to methods and apparatuses for rapidly producing a plasma jet and injecting it at high velocity into a confined target plasma, for purposes including the mitigation of an emerging disruption event in the target plasma, such as can occur in magnetically confined plasma fusion devices.

High-temperature plasmas consist of mixtures of electrons, positively charged ions, and gaseous neutral atoms or molecules. The controlled magnetic confinement of such plasmas has been the subject of considerable research over a period of decades as part of the worldwide effort to achieve controlled nuclear fusion for energy production purposes. In the various devices designed for this purpose, magnetic fields are used to locate and confine a plasma within a containment vessel, both for the purpose of attaining the high temperatures and energy levels necessary to result in nuclear fusion, and for the purpose of preventing the high-temperature plasma from contacting the interior walls of the containment vessel.

A phenomenon known as a major disruption can occur if the magnetic confinement mechanism fails and the plasma is allowed to expand and contact the walls of the containment vessel. Such disruptions are created by macroscopic instabilities in the plasma that cause a rapid thermal quench of the plasma. During a disruption a large amount of the plasma thermal energy and the confinement magnetic field energy is transferred to the wall of the containment vessel. This process is typically rapid and unpredictable and can cause significant damage to the containment vessel, up to and including melting and even vaporization of portions of the vessel wall material. Also, because of the high magnetic field strengths used to contain the plasma, a disruption phenomenon can produce large and dynamic magnetic forces that can damage the mechanical structure of the containment vessel and associated equipment.

A plasma disruption typically occurs in two phases. The first is a thermal quench phase, in which the plasma rapidly cools as it expands and contacts the interior walls of the containment vessel with the loss of magnetic confinement, typically on a time scale of a few milliseconds. The second is a current quench phase, in which the previously confining magnetic field decays over a period of several tens of milliseconds, releasing the energy stored in it through resistive heating of the remaining cooler, higher resistance plasma, and through high-energy, high-current runaway electron beams that deposit their energy locally in the interior walls of the containment vessel, potentially causing significant damage.

Because of the potential costs and risks of an uncontrolled disruption event in a large magnetically confined plasma facility, such as the International Thermonuclear Experimental Reactor (ITER) now under construction, a need has been recognized for processes and apparatuses for preventing, suppressing and mitigating the damage resulting from a disruption event. While the effort to refine and improve magnetic confinement technologies continues so as to avoid or minimize the frequency of plasma disruptions altogether, it has nevertheless also been sought to develop specific processes and apparatuses that can be used to minimize the effects of major disruptions if and when they do occur.

Approaches to preventing the damage that can be caused by a plasma disruption event are known as disruption mitigation. In disruption mitigation an emerging plasma disruption is detected at an early stage in its development and is quickly suppressed before it can cause significant damage. The most common approach to disruption mitigation involves quickly dissipating and harmlessly radiating the plasma thermal energy and the confinement magnetic field energy, which in a device such as the ITER can have a total plasma and magnetic energy density as high as approximately 1 gigajoule (GJ) in a volume of approximately 1,000 cubic meters. This process involves conversion of the plasma energy into radiation while simultaneously increasing the density of free and bound electrons in the plasma by a factor of approximately 100 over the entire plasma cross section; all within a time period that is less than the duration of the thermal quench phase. This process cools the plasma through ionization and radiation processes and suppresses the conversion of the magnetic field energy into an avalanche of high-energy runaway electrons by slowing down and thermalizing them via collisional drag, which would otherwise reach the wall of the containment vessel and cause its localized melting or even vaporization.

One specific approach to disruption mitigation is known as the impurity injection method. In this method an impurity material is quickly accelerated and injected into a target plasma as soon as an emerging disruption is detected; i.e., before it has evolved into a uncontrolled disruption capable of causing damage. The impurity material absorbs thermal energy from the target plasma and magnetic field energy from the confining magnetic field, resulting in ionization of the impurity and harmless radiation of energy therefrom. This process globally distributes energy from the target plasma and thus limits the temperature of the plasma that may come into contact with the walls of the containment vessel and also reduces or eliminates runaway electron beams.

In order to achieve efficient penetration of the magnetically confined target plasma with an impurity material, ionization and acceleration of the impurity in the form of a plasma itself is advantageous.

In this regard it has been previously known to inject molecular hydrogen (H₂) into a magnetically confined plasma by pulsed electrical heating of a quantity of solid titanium hydride (TiH₂), which causes the TiH₂ to dissociate into metallic titanium and gaseous hydrogen (H₂). The resulting hydrogen gas is then ionized, accelerated, and injected into an adjacent containment vessel containing the target plasma. A device for achieving such injection, but intended the purpose of refueling, or increasing the hydrogen content of a confined plasma and not for purpose of disruption mitigation, has been reported with regard to the experimental Russian Globus-M tokamak, in Voronin, A. V., et. al., “High kinetic energy dense plasma jet,” Nukleonica 51(1), pages 85-92, 2006.

The impurity injection mitigation method preferably utilizes an impurity gas of relatively high mass and atomic number in order to be effective at absorbing and radiating energy from the plasma. The impurity gas must also have sufficiently high specific directed kinetic energy, commonly referred to as ram pressure, to penetrate the confining magnetic field and reach the core of the confined plasma, while also being able to radiate energy on the fast disruption time scale in order to achieve real-time mitigation.

High-pressure jets of neutral gaseous species, such as the inert gases neon or argon, have been considered for this purpose in a variation of the impurity injection method known as massive impurity injection. However, a well-recognized problem with the use of neutral inert impurity gases is that once the gaseous atoms are ionized in a thin outer layer of the hot plasma, they can no longer penetrate the confining magnetic field of the plasma unless they possess a sufficiently high velocity to overcome the force of the magnetic field. This problem could conceivably be overcome with a sufficiently high gas velocity, but the injection velocity of a neutral gas is limited to a relatively low value and thus the mitigation process would necessarily rely on the inward propagation of a cooling front wave and enhancement of magneto-hydrodynamic (MED) activity to achieve mixing of the impurity gas with the core plasma. These processes take a relatively long time, estimated to be at least 40 milliseconds for the ITER device. Moreover, controlling the sequence and timing of these processes is difficult, yet they are necessary to obtain reliable and prompt disruption mitigation with an inert gas.

One approach to the problem of delivering an impurity having sufficient mass to penetrate a magnetically confined plasma has been the proposed use of a “dusty” injection plasma, which is an ionized gas containing relatively very heavy particles of carbon or other particulate material having a size on the order of 10 microns in diameter. One problem with such an approach, however, is that the injection plasma must be electromagnetically accelerated, but the charged particulate matter in a dusty plasma is relatively heavy, such that it must be dragged by the low mass ions of the ambient accelerated injection plasma through collisions, a process that substantially limits the velocities that can be obtained with micron-sized particulate materials.

Relatedly, it has been recently demonstrated that gaseous molecular hydrogen (H₂) produced by pulsed electrical heating of a quantity of solid titanium hydride (TiH₂) and carbon fullerene (C₆₀), which causes the TiH₂ to dissociate into metallic titanium and gaseous hydrogen (H₂), results in heating and resulting sublimation of the C₆₀ by the produced hot H₂, resulting in a gas mixture in which the C₆₀ is an impurity of high mass and atomic number of interest for such an impurity injection mitigation method. The demonstrated production of such a very high density C₆₀ source, suitable for use in such an impurity disruption mitigation system, has been reported by Bogatu, I. N., et al., “Disruption Mitigation with Plasma Jets for ITER,” at the 23rd IAEA Fusion Energy Conference, Daejon, Korea, Oct. 11-16, 2010 (conference paper EXS-P2-01).

Accordingly, it is the object and purpose of the present invention to provide an apparatus and method for rapid production of a plasma jet on demand.

In particular, it is a purpose of the present invention to provide an apparatus and method for producing a plasma and injecting it as a jet into a magnetically confined target plasma.

More specifically, it is an object and purpose of the present invention to provide an apparatus and method for rapid production and introduction of an impurity plasma into a magnetically confined target plasma for the purpose of mitigating an emerging disruption in the target plasma.

### SUMMARY OF THE INVENTION

The present invention provides a method and apparatus for rapidly producing a plasma jet on demand.

In a preferred embodiment, the invention includes a pulsed power, solid-state plasma injector that is operable to produce an impurity plasma suitable for mitigating a disruption in magnetically confined target plasma, and to accelerate and inject the impurity plasma at a high velocity in the form of a plasma jet into the target plasma.

The apparatus of the present invention includes a solid-state pulsed power plasma jet injector having a gas source cartridge and a plasma accelerator. The gas source cartridge includes coaxial inner and outer, electrically nonconductive containment tubes, with the inner tube having multiple perforations therein. The containment tubes are spaced by a pair of electrically conductive end ring electrodes that locate and space the inner and outer tubes in a coaxial configuration. The nonconductive containment tubes and the conductive end ring electrodes define an annular volume that contains a solid gas source material that may include a metal hydride, and which in a preferred embodiment may be titanium hydride (TiH₂). In an application directed to the mitigation of a disruption in a magnetically confined target plasma, the solid gas source material preferably consists essentially of a solid mixture of titanium hydride and a large atomic weight or molecular weight material such as fullerene (C₆₀).

An electrical cartridge driver connected to the end rings includes a power supply capable of discharging a high power electrical current through the cartridge and thereby rapidly heating the gas source material to produce a gas, which in the preferred embodiment consists essentially of a mixture of gaseous hydrogen and fullerene, and which may include gaseous fullerene generated by sublimation as well as suspended nanoparticles of fullerene that are swept up and entrained in the gas flow as the gaseous hydrogen is generated and discharged from the cartridge.

The plasma jet injector further includes a tubular accelerator passing through the inner containment tube of the gas source cartridge, and which includes an electrically conductive outer accelerator tube and an electrically conductive inner electrode rod extending coaxially therein along the longitudinal central axis of the accelerator tube. The outer accelerator tube is sized in outer diameter to correspond with the inner diameter of the inner cartridge tube and is also perforated, with the perforations of the outer accelerator tube being aligned with the perforations in the inner containment tube of the gas source cartridge. The accelerator is powered by an electrical accelerator driver that includes a power supply connected to the outer accelerator tube and the inner accelerator electrode rod. The accelerator driver operates to partially ionize the gas introduced into the accelerator tube from the gas cartridge to form a plasma, and to accelerate and emit the plasma as a high velocity plasma jet.

In a preferred embodiment, a separate pre-ionization electrical power source is utilized to provide a well-defined, localized ionization region in the gas upon its introduction into the accelerator tube and prior to actuation of the accelerator driver. The purpose of pre-ionizing the gas is to define the initial axial location of the accelerator driver current path through the gas. Such a pre-ionization source may be an ultraviolet (UV) light source, an electron beam source, or a radio frequency (RF) pre-ionization source.

The perforations in the inner containment tube and in the outer accelerator tube are distributed in an azimuthally symmetrical arrangement around the tubes so as to result in radially symmetrical introduction of gas into the accelerator tube from the gas source cartridge.

A preferred gas source material comprises a packed, solid mixture of granular titanium hydride and fullerene. In accordance with other aspects of the invention the mixture may consist of spherical grains of titanium hydride coated with fullerene, in order to optimize the sublimation of the fullerene as well as the flow the resulting gas mixture through the packed source material and into the accelerator tube.

As noted above and also disclosed in U.S. patent application Ser. No. 12/002,420, a solid mixture of titanium hydride (TiH₂) and fullerene (C₆₀) can be resistively heated to dissociate the titanium hydride into solid titanium and gaseous molecular hydrogen (H₂), while also sublimating the solid fullerene to produce gaseous fullerene. The resulting gaseous mixture can be ionized and accelerated, and the large-weight molecular fullerene component of the mixture renders the resulting plasma jet particularly suitable as an impurity plasma for injection into a magnetically confined target plasma to mitigate an emerging disruption.

The method of the present invention, which may be practiced through the use of the apparatus of the present invention, includes the steps of applying a high power electrical current to a solid gas source material to produce a gas by resistive heating; followed by the steps of introducing the resulting gas radially and azimuthally symmetrically into an accelerator tube, subsequently ionizing the gas to form a plasma, and accelerating the plasma to a high velocity to form a plasma jet. In a preferred embodiment of the method an impurity gas is formed, ionized, accelerated, and injected as a high velocity jet into a magnetically confined target plasma for the purpose of mitigating an emerging disruption in the target plasma.

These and other aspects of the present invention are further described in the following detailed description of the invention and illustrated in the accompanying drawings.

### BRIEF DESCRIPTION OF THE DRAWINGS

The accompanying drawings illustrate a preferred embodiment of the present invention. In the drawings:

FIG. 1 is a side view in cross section of a preferred embodiment of a plasma jet injector constructed in accordance with the present invention;

FIG. 2 is an isometric view in partial cross section of the plasma jet injector shown in FIG. 1

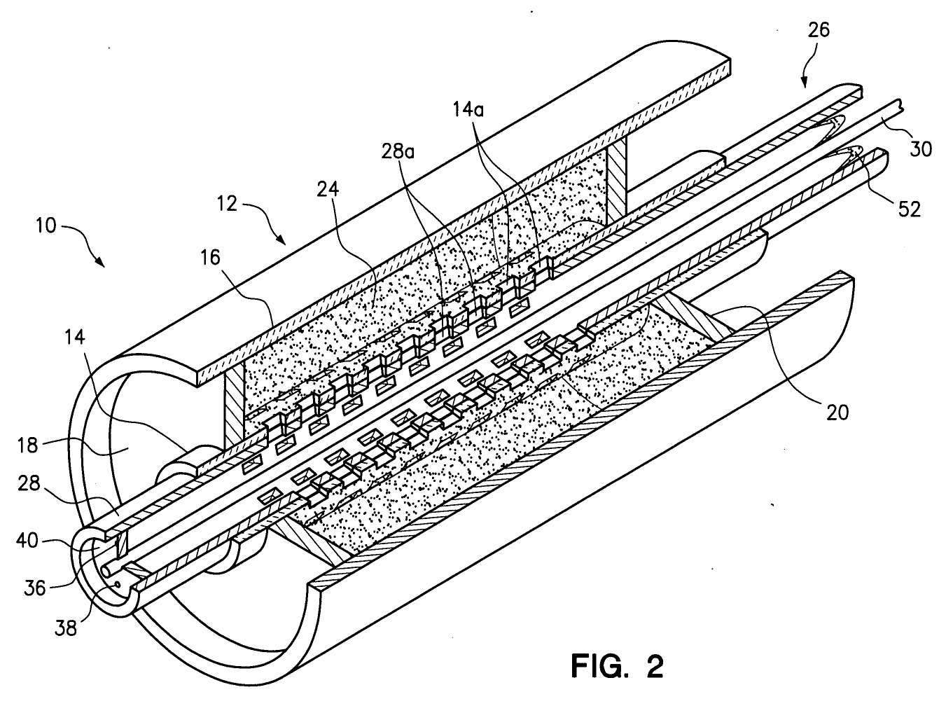

FIG. 3 is an end view in cross section, taken along section line 3-3 of FIG. 1; and

FIG. 4 is a schematic illustration of the plasma jet injector apparatus of the present invention, as it may be utilized in connection with a large magnetically confined plasma fusion device.

### DETAILED DESCRIPTION OF THE INVENTION

Referring to the Figures, a preferred embodiment of the apparatus of the present invention is embodied in a solid-state, pulsed power plasma jet injector 10 for use in the mitigation of an emerging disruption in a magnetically confined target plasma. The illustrated preferred embodiment is intended for specific application to a plasma containment vessel such as that used in a tokamak, wherein it is desirable to be able to quench an emerging plasma disruption with a pulsed, sub-millisecond injection of an impurity plasma containing large-weight gas molecules or nanoparticles. For this purpose, a solid mixture of titanium hydride (TiH₂) and fullerene (C₆₀) is used as the primary gas source for the formation of an impurity plasma, as further described below.

The plasma jet injector 10 includes a tubular gas cartridge 12 that includes a pair of concentric, inner and outer, electrically nonconductive containment tubes 14 and 16, respectively. A pair of spaced, electrically conductive end rings 18 and 20 space and locate the containment tubes 14 and 16 in a coaxial arrangement with respect to one another. The end rings 18 and 20 also function as output electrodes of a high power electrical cartridge driver 22. The containment tubes 14 and 16 and the end rings 18 and 20 collectively define an annular cylindrical volume which is packed with a solid mixture 24 of titanium hydride (TiH₂) and fullerene (C₆₀), described further below.

The inner containment tube 14 is sized in internal diameter to snugly enclose a tubular plasma accelerator 26, which includes an electrically conductive outer accelerator tube 28 and an electrically conductive inner electrode rod 30 that extends along the central cylindrical axis of outer accelerator tube 28. The outer accelerator tube 28 and the inner electrode rod 30 function as electrodes that are connected to the outputs of an electrical accelerator driver 32.

The preferred embodiment further includes an electrical pre-ionizer driver 34, the outputs of which are connected to terminals 36 and 38, which are embedded in a circular, electrically nonconductive end wall 40 at one end of accelerator tube 28. The terminals 36 and 38 pass through the end wall 40 and are connected to elements of a circular array of metallic elements 42 located on the interior surface of end wall 40, so as to function as an ultraviolet flashover source for pre-ionization, as further described below. Actuation of the pre-ionizer driver 34 results in partial ionization of gas in the accelerator 26 and creates a well-defined initial current path for current subsequently introduced by the accelerator driver 32.

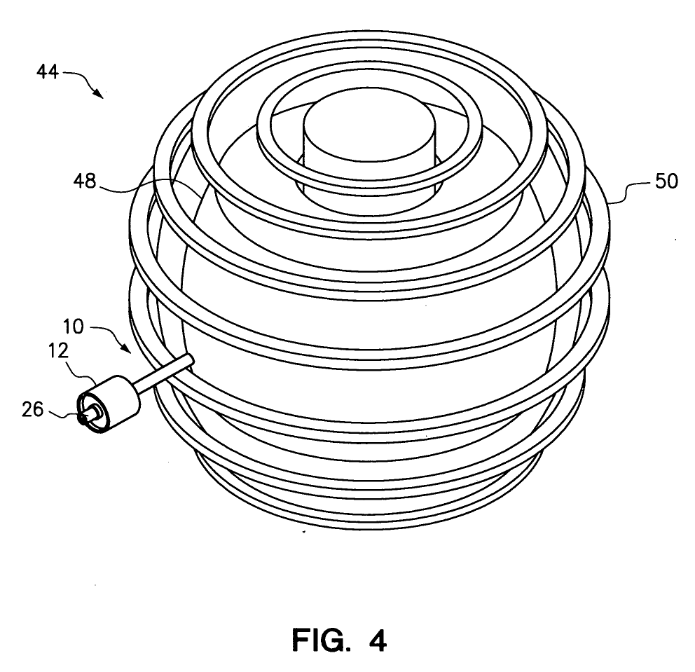

In FIG. 4 the plasma injector 10 is shown as connected to large magnetically confined plasma fusion device 44. The plasma fusion device 44, which forms no part of the present invention, includes a plasma containment vessel 48 in which a magnetically confined target plasma (not shown) is maintained and confined by a magnetic field produced by magnetic coils 50.

The inner containment tube 14 of gas cartridge 12 contains multiple, radially extending perforations 14a, which are aligned with corresponding perforations 28a in outer coaxial accelerator tube 28. Both sets of perforations 14a and 28a are arranged in an azimuthally symmetric arrangement so as to achieve a symmetric distribution of the radial introduction of gas into the accelerator 26.

In operation, the cartridge driver 22 is actuated upon the detection of an emerging disruption in the target plasma 48 in the adjacent plasma containment vessel 48 (FIG. 4). An emerging disruption may be identified by monitoring certain diagnostics that measure parameters of the plasma, such as changes in the magnetic field strength or the plasma temperature. In some situations an incipient disruption can be avoided by taking prompt preemptive actions. However, when a disruption cannot be avoided, it is desirable to mitigate it by actuation of the plasma injector 10 of the present invention. Processes for detecting and avoiding a disruption are not part of the present invention.

The timing relationship between actuation of the gas cartridge 12 and actuation of the accelerator 26 is sequential, with actuation of the gas cartridge 12 proceeding first. Upon actuation of electrical cartridge driver 22, a high power electrical current is passed through the TiH₂/C₆₀ mixture 24, causing rapid resistive heating of the mixture 24 and resulting in generation of gaseous molecular hydrogen (H₂) by dissociation of the titanium hydride and production of gaseous fullerene by sublimation. The heating process may also result in production of suspended nanoparticle fullerene by ablation, as particles of fullerene are swept up and entrained in the hot, rapidly expanding mixture of gaseous hydrogen and fullerene that is discharged from the cartridge 12. The process of producing the gaseous mixture of hydrogen and fullerene and discharging it through the perforations 14a and 28a and into the accelerator 26 takes place over a period of approximately a few hundred microseconds.

Upon the hydrogen and fullerene being introduced into the accelerator 26, they are partially pre-ionized by actuation of the pre-ionizer driver 34. Actuation of the pre-ionizer driver 34 with a high voltage electrical pulse causes an electrical breakdown between the metallic elements 42 on the interior surface of end wall 40 to produce a plasma which functions as an ultraviolet flashover source, which partially ionizes the adjacent gases and creates a well-defined initial path for a subsequent accelerator driver current. Other suitable pre-ionizers include other sources of ultraviolet (UV) radiation, electron beams, or radio frequency (RF) radiation.

Following the pre-ionization of the hydrogen and fullerene, a high power electrical acceleration current is discharged from the electrical accelerator driver 32, which takes place over a time period of a few tens of microseconds. Passage of the acceleration current between the outer accelerator tube 28 and the inner electrode rod 30, through the pre-ionized gas mixture, results in further ionization of the gas mixture and its acceleration along the length of the accelerator tube 28 as a plasma slug 52.

The ionized and accelerated plasma slug 52 is ejected as a plasma jet from the open end of accelerator tube 28 and is injected into the target plasma in adjacent containment vessel 48 at a velocity of several tens of kilometers per second within a few hundred microseconds, where it mitigates the emerging disruption by quickly converting the thermal and magnetic energy of the target plasma into radiation that is harmlessly emitted without damaging the containment vessel 48. This entire process takes place within a millisecond.

The preferred impurity gas mixture consists essentially of hydrogen, which has a very low molecular weight of 2 grams/mole, and fullerene, which has a high molecular weight of 720 grams/mole, which is very high for a stable molecular gaseous species. This combination of high- and low-molecular weight gaseous species can then be partially ionized to create what is sometimes referred to as a plasma slug. Fullerene is a carbon molecule consisting of 60 carbon atoms connected in an array that is approximately spherical in geometry. It is also casually referred to as buckyball or buckminsterfullerene. Fullerene is commercially available in the form of a black granular powder that is stable at room temperature. Fullerene sublimates, without significant decomposition, at a nominal temperature of approximately 800 K. Upon sublimation, gaseous fullerene can be ionized to form positively charged fullerene ions.

Titanium hydride is also commercially available and is a solid at room temperature. Upon being heated to a temperature in excess of approximately 573 K, titanium hydride decomposes to produce molecular hydrogen gas (H₂), leaving behind solid metallic titanium. Such heating produces approximately 448 cm³ of hydrogen per gram of titanium hydride at standard temperature and pressure, or a total number of 1.2×10²² H₂ molecules.

The solid mixture 24 preferably consists of titanium hydride and fullerene in the ratio of approximately 2.5 to 1.0 by weight, which is based on the determination that a molecular ratio of gaseous hydrogen to fullerene of approximately twelve to one is necessary for adequate sublimation of the fullerene.

In accordance with the preferred embodiment of the present invention, the solid mixture of fullerene and titanium hydride is formed by infusing a quantity of solid, granular titanium hydride with a saturated solution of fullerene dissolved in a suitable volatile solvent, for example 1,2,4 trichlorobenzene, carbon disulfide, or toluene. The infused mixture is then heated to a temperature of less than 300° C. to evaporate and remove the solvent without dissociating the titanium hydride or sublimating the fullerene, thus leaving behind a solid mixture made up of solid, fine-grained fullerene deposited in the interstitial spaces within and on the granular titanium hydride. If we assume that TiH₂ grains are identical hard spheres, then packing them within the cylindrical shell volume of the gas cartridge 12 is related to the famous Kepler's conjecture: the maximum density of packed spheres or the most efficient way to pack identical spheres as tightly as possible within a given volume. The maximum percentage of occupancy is f=π/\sqrt{18}≈74% according to Kepler's conjecture. This is the asymptotic limit, as in practice this value cannot be attained even with spherical TiH₂ grains. The inter-granular space volume is a key parameter for heat, sublimation and molecular gas ejection, and is optimally determined by the diameter, the number, and the type of packing of the grains for the actual dimensions of the gas cartridge 12. The resulting solid mixture 24 of non-reacting components can be stored indefinitely until needed.

The gas cartridge 12 is intended to be replaced or refilled after each actuation, particularly in the application of the invention to disruption mitigation, even though the solid source of hydrogen and fullerene may not be exhausted with each use. While disruptions are normally rare events, an unmitigated disruption carries the risk of substantial damage and ordinarily results in the target plasma containment device being idled for extensive periods of time for repair or refurbishment. Thus there is a need for an apparatus such as the present invention, which can remain idle and unattended for long periods of time, yet which can be actuated within a millisecond when needed.

In a preferred embodiment, the TiH₂ grains are coated with a film of C₆₀. Depending on the energy requirements necessary to sublimate C₆₀ from a thick film coating, the C₆₀ can be coated onto identical spheres of Ti or TiH₂; with the coated spheres then mixed with uncoated spheres to achieve the overall desired ratio of TiH₂ to C₆₀.

Nanoparticles formed from materials other than C₆₀ may also be used. For example, sub-nanometer particles of metals or other high Z materials may be used instead of fullerene, using the same process and apparatus for solid-state pulsed power cartridge injection as is described here. One alternative impurity component consists of sub-nanometer particles of gold (A=197, ρ=19.32 g/cm³, and having a melting temperature of 1,337 K and a vaporization temperature of 2,873 K) particles. Clusters of 0.65 nm diameter composed of ˜9 Au atoms and with a mass ˜2.9×10⁻²¹ g, comparable with that of C₆₀, are commercially available as colloidal gold. Another material useful as an impurity plasma component for disruption mitigation is tungsten (W), as recent technology to produce large quantities nanometer-size tungsten particles has been developed. Other large and hence more massive nanoparticles are also feasible, as the C₆₀ molecule is already 360 times more massive than molecular hydrogen (H₂). Such materials may however require higher temperatures in the gas cartridge 12 to achieve sublimation, vaporization or entrainment with the exhausted gas, and thus associated higher energy electrical sources for the cartridge driver 22. This is the case for any dusty plasma because, depending on the extent to which nanoparticle material is discharged into the accelerator 26, in lieu of or in addition to a gaseous carrier material, typical nanoparticles will be significantly more massive than the gaseous species.

Also, with regard to the light atomic weight component of the impurity plasma, while the present invention is described herein by reference to the use of titanium hydride and its dissociation to produce hydrogen, it should be understood that the heavier isotopes of hydrogen, i.e., deuterium and tritium, are equally suitable for use in the present invention, and may in fact offer certain advantages in the practice of the invention in connection with magnetically confined plasma vessels intended to achieve nuclear fusion. Thus the term “hydrogen” herein includes the hydrogen isotopes, deuterium and tritium, and it should be further understood that the ratio of any hydrogen isotope to another in the source gas may be varied in order to achieve particular performance characteristics.

In accordance with the present invention the solid mixture 24 of titanium hydride and fullerene is heated to a temperature of between approximately 573 K and 873 K, which results in dissociation of the TiH₂ to produce gaseous hydrogen (H₂) and sublimation of the solid fullerene to produce gaseous fullerene, leaving behind solid titanium that is partially depleted of hydrogen. In addition to direct sublimation of fullerene to the gaseous state, some fullerene may be ablated and introduced in solid nanoparticle form. The solid mixture 24 is heated as rapidly as possible in order for the injector to generate, ionize and subsequently deliver hydrogen and the impurity component to quench an emerging plasma disruption as quickly as possible.

As described above, rapid heating is accomplished by electro-thermal resistive heating, which is attained by passing a high power electrical current through the solid mixture 24. A suitable source for such a high power electrical current is a bank of charged electrical capacitors contained in the cartridge driver 22, which is preferably capable of providing a current of approximately 200 kiloamperes through a volume of approximately 100 cm³ of the mixture of titanium hydride and fullerene. Pulsed electro-thermal heating of the mixture is desirable because it produces a discrete parcel of hot gaseous hydrogen and fullerene within a period on the order of 10 microseconds. The fullerene component of the parcel may exist as gaseous fullerene or as a mixture of gaseous fullerene and solid fullerene nanoparticles.

As also described above, the purpose and function of the plasma accelerator 26 is to receive the radially injected gas parcel formed in gas source cartridge 12, and to then ionize the gas and accelerate the resulting plasma to a high velocity, using JxB electromagnetic forces formed by driving a current through the plasma between the accelerator tube 28 and the axial accelerator rod 30. The pre-ionizer driver 34 is actuated prior to actuation of the accelerator driver 32, for the purpose of providing a well-defined initial current path for the current from accelerator driver 32. The acceleration of the resulting plasma is caused by JxB forces that are the result of the interaction between ions and electrons traveling in radial directions, which is associated with the radial current flow through the pre-ionized gas between the two coaxial accelerator electrodes (tube 28 and rod 30), and the azimuthal magnetic field associated with the axial current flowing along both the accelerator inner rod 30 and outer tube 28 to the injected and pre-ionized plasma from the accelerator driver 32. As such, it is desirable that the initial current path through the injected gas be at the edge of the parcel of injected gas nearest the closed end of accelerator tube 28, as any injected gas located upstream of the initial radial accelerator current path may not be accelerated efficiently. It is therefore preferred that the pre-ionizer driver 34 be used in conjunction with the accelerator driver 32, being activated within a few microseconds prior to actuation of the accelerator driver 32, so as to better define the initial accelerator current path through the injected gas parcel.

During the acceleration process, both the degree of ionization and the electrical conductivity of the plasma plug 52 progressively increase as it is accelerated by the JxB forces acting on it, until it is emitted as a jet from the open end of the accelerator.

In the specific application of a pulsed, sub-millisecond plasma jet injector for application to tokamak disruption mitigation, the accelerator 26 will ionize and accelerate the mixture of H₂ and C₆₀ to a velocity of several tens of km/s for rapid injection into the tokamak containment vessel. Radial and azimuthally symmetric injection of the gas parcel into the coaxial accelerator 26 from a coaxial source provides optimum axial localization and a preferred radial profile of the injected gas mass to be accelerated, as well as optimum coupling to the accelerator 26.

More particularly, the mixture of molecular hydrogen, gaseous fullerene and fullerene nanoparticles is ionized to form an impurity plasma in the coaxial accelerator 26, and accelerated along accelerator tube 28 until it is injected as a plasma jet into the target plasma 48. For efficient impurity mass delivery, shock heating of the impurity gas initially at rest ahead of the pre-ionized current carrying and accelerating plasma, which includes the pre-ionized impurity gas which initially carried the accelerator driver current and the gas and nanoparticles swept up and entrained by the movement of the accelerated plasma, preferably results in a plasma jet that is fully ionized upon its emission from the accelerator 26. Gas not fully ionized, or nanoparticles insufficiently ionized, may remain in the accelerator 26 after the plasma jet exits and thus constitutes an inefficiency of the system. In the case of the accelerator 26 described here, operating on a time scale of a few 10's of microseconds, and over a length of a few 10's of centimeters, this condition is usually satisfied.

As noted, because of the presence of nanoparticles in the plasma, such a plasma is referred to as a “dusty plasma,” or more precisely, a “nano-dust plasma.” The C₆₀ fullerene molecule, with a diameter of about 0.7 nanometer, is easily ionized, as its first ionization energy is 7.58 eV, which is significantly lower than the first ionization energy of a single carbon atom, which is 11.26 eV. Thus the ionized, positively charged nanoparticles of C₆₀ constitute charged ionic components of the plasma, and due to their specific charge (charge to mass ratio) they are more likely to be electromagnetically accelerated than merely dragged by means of mechanical collision processes.

An advantage of the present invention over previously known devices is that the C₆₀ is introduced radially into the accelerator 26, as opposed to axially into one end of an accelerator tube as is disclosed in the paper by Bogatu, I. N., et. al., referenced above. Such advantages primarily relate to scaling of the mass output and its injected spatial profile relative to that from an accelerator having an axial source.

More specifically, one advantage of radial introduction of the fullerene or other nanoparticles arises from the several time scales involved in the heating and mass transfer process. These include the duration of the electrical pulse and the associated rate of heating of the solid mixture 24 through an electrical current skin depth effect which occurs in the outer layers of the TiH₂ grains; the subsequent duration and rate of cooling of the TiH₂ grains, which are partially depleted of hydrogen after having been heated; and the mass flow rate of the mixture of hydrogen carrier gas and sublimated or entrained nanoparticle fullerene as it travels through the inter-granular spaces between the packed TiH₂ grains.

The time scale for the electrical heating of the TiH₂ can be adjusted through changes in the electrical driver parameters. This can be relatively easily accomplished by extending the heating duration from microseconds to tens of microseconds or longer. Energy delivery faster than a few microseconds is not necessary in the application of the invention to disruption mitigation, because of the longer time scale, on the order of tens of microseconds, that is associated with TiH₂ cooling and gas exhaust from the gas cartridge 12.

The flow rate of the gas released from the packed TiH₂ grains and introduced into the accelerator 26 is limited by the sound speed of the gas, the inter-gap spacing between grains, and the convoluted flow path through the grains. A positive consequence of the convoluted path between the packed grains is that the hot H₂ can sublimate and entrain more C₆₀ in the resulting impurity gas mixture.

The cooling rate for the TiH₂ grains depends on the mode of operation. In the case of a fast electric impulse of less than ˜10 microseconds, the cooling is dominated by self-cooling of the grains and the energy loss to the produced H₂ and C₆₀ gas. The self-cooling is a combination of uneven heating, with the highest temperatures at the grain-to-grain points of contact where the current density is the largest, and an electrical skin-depth effect that limits the current penetration into the grain, resulting in primarily surface heating layer of the grain to a relatively higher temperature. As a result, the surface layer of the TiH₂ grains cools as heat diffuses into the center of the grain. This surface layer skin depth effect has some advantage in that the energy required to heat the surface layer of the grain, which is the portion of the grain that contributes most of the H₂, is significantly less than that required to heat the entire grain to the same temperature, by a factor of as much as 100 depending on grain size.

An estimate of the upper limit of the time during which a significant portion of the TiH₂ grain surfaces remains hot can be estimated from the duration of the H₂ exhaust from the gas cartridge 12, as disclosed in the paper by Bogatu, I. N., et. al., referenced above, is on the order of 50-100 microseconds. This time scale limits the depth from which gaseous C₆₀ can be emitted before cooling begins to re-condense the C₆₀ gas remaining in the gas cartridge 12 back onto the TiH₂ grains. The depth can be estimated from the duration, approximately 250 microseconds, and velocity, approximately 0.15 km/s, of the C₆₀ exhausted into a vacuum, as reported in the paper by Bogatu, I. N., et. al., “Disruption mitigation with plasma jets for ITER,” submitted for publication in the Journal of Fusion Energy in December 2010, which implies that the C₆₀ travels ˜3.75 cm in the C₆₀ exhaust duration as an upper limit. It is expected that the velocity in the tightly packed TiH₂ grains is significantly less, partly because of the restricted inter-grain spacing (open volume between grains ˜33%), associated indirect paths required for the C₆₀ to get to the exhaust (nozzle) surface of the packed TiH₂ grains, and further restriction of the flow at the exhaust apertures 14a and 28a. If an ad hoc factor of four is taken as the velocity difference between vacuum exhaust and inter-grain velocities, this analysis suggests that only ˜1 cm of the TiH₂ depth, relative to the exhaust aperture surface, can contribute to the C₆₀ delivered by a single electrical pulse on the order of 10 μs in duration. If the TiH₂ grains are sized significantly different from the nominal 1 mm diameter grains considered here, this estimate would be vary accordingly. It should also be noted that having a TiH₂ and C₆₀ loading with more depth could result in a reduction of the depletion rate of the “useable” C₆₀ near the exhaust surface, as the flow of C₆₀ from deeper within the packed grains replenishes the C₆₀ nearer the exhaust surface—an approach which would extend the useful number of discharges for which a high level of C₆₀ exhaust is maintained for repetitive applications, however requiring more electrical energy to heat the additional TiH₂ and C₆₀.

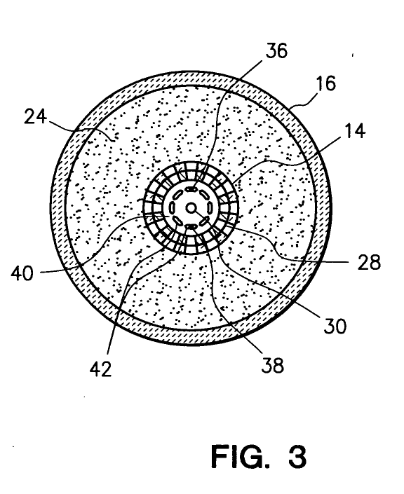

The limited depth contribution to C₆₀ exhaust means that the useable volume of TiH₂ and C₆₀ for single fast pulse applications is limited to that roughly defined by the exhaust surface area A, multiplied by the accessible single-shot depth d, ˜1 cm. This volume scales with the radius r, as r², for the axial nozzle ejection source geometry as shown in FIG. 3. Alternatively, for the proposed coaxial nozzle ejection source geometry shown in FIG. 4, the surface area scales with r times l, where l is the axial length of the exhaust/nozzle surface. These scalings show that for l>r/2, an increase of the usable TiH₂ grains and C₆₀ volume (or mass) is obtained by the coaxial C₆₀ source over that of an axial C₆₀ source for a given coaxial accelerator radius r. For the application of interest, radial injection of C₆₀ into a ˜3 cm outer radius coaxial accelerator 26, over a coaxial injection length of ˜4 cm, results in a useable volume (or mass) approximately 10 times greater than that in a device utilizing the axial injection geometry.

An additional improvement in the source delivery may be obtained by using approximately spherical TiH₂ grains of substantially uniform size, as opposed to grains of irregular size and/or shape. Protrusions on irregular grains tend to crumble under compression, which compression is nevertheless necessary to some extent in order to ensure adequate electrical conductivity. Crushing or crumbling of the grains has the effect of restricting the flow of gas through the mixture and also tends to increase the surface contact area between grains, which reduces the local electrical resistance and hence local heating where the highest grain surface temperatures are expected to occur.

Another advantage of radial injection is that the injected gas is more axially localized in the accelerator tube 28, with the gas being driven against the center rod 30 also having the beneficial effect of creating a preferred radial density profile that peaks at the center rod 30. This in turn creates a condition that is conducive to reducing or delaying current blow-by instability, a phenomenon that can reduce the coupling efficiency of the H₂ and C₆₀ injected gas mass to the accelerated plasma jet mass. Current blow-by instability, in a coaxial geometry such as that described here, occurs because of the radial dependence of the JxB electromagnetic force associated with the acceleration process. The magnetic pressure which pushes the plasma depends on B²(r)˜1/r², resulting in higher forces near the center electrode. Without an initial radial mass profile in the accelerator that is peaked at the center electrode, the accelerating current/plasma front can advance along the center electrode faster than further out radially. This leads to the current on the center electrode reaching the axial end of the initial injected gas distribution before the bulk of the gas at larger radius has been accelerated. Current blow-by thus results in a radially non-uniform axial mass acceleration, as well as a degree of radial acceleration of the mass nearest the center electrode. If the current blow-by occurs earlier enough, i.e. if the current penetrates along the center electrode 30 significantly ahead of the axial motion of the plasma near the outer electrode, i.e., the accelerator tube 28, the resulting magnetic field profile can push the remaining mass radially toward the outer electrode, thereby limiting the plasma mass ejected from the accelerator 26; thereby resulting in poor coupling or delivery of the initial accelerated mass to the exiting plasma jet 52.

Finally, the annular geometry of the gas cartridge 12 results in relatively uniform axial introduction of gas along a selected length of the accelerator tube 28, such that upon electrical actuation of the accelerator 26 the region of gas breakdown can be better defined, especially with the use of a pre-ionizer.

The coaxial geometry also allows a much more convenient implementation of the pre-ionizer driver 34 to assist in defining the desired initial path for the accelerator driver current through the injected gas in the accelerator 26. Acceleration of the ionized gas mass is due to the JxB forces that are the result of the interaction between the radial motion of ions and electrons associated with the radial current flow between the two coaxial accelerator electrodes 28 and 30, and the azimuthal magnetic field associated with the axial current flowing along both the accelerator inner rod 30 and outer tube 28 to the injected and pre-ionized plasma from the accelerator driver 32. As such, it is desirable that the initial current path through the injected gas be as far upstream towards the closed end wall 40 of the accelerator 26 as possible. At the same time, any injected gas that is located upstream of the initial radial accelerator current path may not be accelerated efficiently or at all. Thus it is preferred that the auxiliary pre-ionizer driver 34 be used in conjunction with the accelerator driver 32, and that it be actuated just prior to actuation of the accelerator driver 32, preferably within a few microseconds, to better define the initial current path of the accelerator driver current through the injected gas parcel. Other suitable pre-ionizers may include other sources ultraviolet (UV) radiation, as well as electron beam or radio frequency (RF) radiation sources configured to illuminate or radiate the appropriate region of the injected gas parcel. In the illustrated preferred embodiment, the annular surface flashover source consists of the circular array of metallic elements 42 positioned on end wall 40, between the accelerator inner rod 30 and outer accelerator tube 28. Application of a high voltage electrical signal from the pre-ionization driver 34 to opposing elements 42 of the array results in electrical discharges which travel between the opposing elements 42, along the surface of the end wall 40, and which in turn result in ablation and heating of a plasma consisting of the end wall material and resulting production of ionizing UV radiation, thereby pre-ionizing the adjacent injected gas. The illustrated shapes of the individual elements 42, each of which includes a pointed tip at both ends, is particularly suited to the production of UV radiation by the phenomenon known as surface flashover.

The level of electrical power applied by cartridge driver 22 is determined by both the temperature desired to be attained and the time period over which the desired temperature must be maintained, as determined by the specific application. Temperatures in excess of 1,200 K can be relatively easily obtained over durations ranging from a few microseconds to milliseconds. While a pulsed, single-shot mode is the preferred method for generating the source gas, repetitive pulsing is also feasible in particular applications. In the specific application to disruption mitigation in a tokamak, where impurity plasma generation and subsequent exhaust of the produced C₆₀ is desirable within a few hundred microseconds, temperatures in the range of 800-1,200 K and electrical pulses on the time scale of 10-50 μs are used.

In the single-pulsed operation of interest for the specific application of a high velocity plasma jet for tokamak disruption mitigation, the cartridge driver 22 preferably consists of two main components; a capacitor bank configured as either a inductor-capacitor-resistor (LCR) circuit or a pulse forming network (PFN), and a high voltage power supply. The high voltage power supply charges the capacitor bank to the desired energy level over an appropriate time period, which for single-pulse operation is typically on the order of a minute. The capacitor bank is then actuated upon detection of an emerging disruption, discharging a current through the gas cartridge 12 within the time scale required. The required electrical current level is dependent on the source cartridge size and the physical characteristics of the source gas material, including for example its temperature dependent electrical resistance. In the case of the preferred source gas cartridge for application to disruption mitigation, the desired level of C₆₀ output requires the cartridge to be sized such that the minimum current levels of interest are on the order of hundreds of kiloamperes. The stored energy requirement associated with such a cartridge source is typically on the order of 15 kJ or more.

The scale of the coaxial accelerator 26 and its associated electrical driver 32 depends on the requirements of the specific application, with key parameters being the total mass to be accelerated and the velocity to which the mass must be accelerated. In the specific application of the preferred embodiment of the present invention to tokamak disruption mitigation, for a mass of 30 mg of C₆₀, accelerated to a velocity ˜30 km/s, the accelerator tube 28 is preferably approximately 0.35 meters in length, with the inner diameter of electrode rod 30 being approximately one centimeter and the outer diameter of the accelerator tube 28 being approximately six centimeters.

As noted above, electrical heating of the gas source material requires the adjacent cartridge containment tubes 14 and 16 to be electrically nonconductive, to ensure that the gas source material 24 carries most or all of the electrical current. The requirement that the source gas cartridge 12 contain the source gas as it is produced places mechanical constraints on the structure of the cartridge containment tubes, as temperatures exceeding 1,200 K and pressures exceeding 100 atmospheres may be produced, dependent on the source design for a specific application. Insulator materials typically considered for applications involving high temperatures and pressures are ceramics, which can include the commonly available alumina (Al₂O₃), boron nitride (BN), or other more specialized ceramic materials.

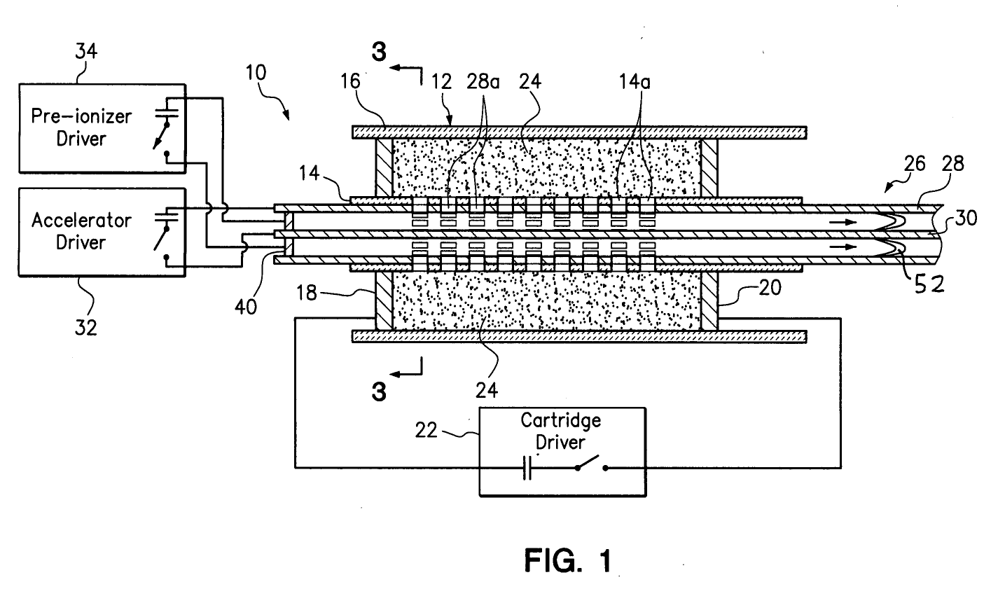

Ceramics are very strong under compressive stress, but are much less so under tensile stress, such as is produced by the rapidly expanding hydrogen source gas. In particular, the strength of inner cartridge tube 14 is reduced by the apertures 14a that are necessary for exhausting the gas radially from the source containment region. An appropriate balance between maximum wall strength and maximum gas porosity is obtained by means of the arrays of apertures 14a in form of segmented slots, as shown in FIG. 1. A method for strengthening the ceramic containment consistent with the overall design of the gas source, besides simply making the ceramic thicker, is to provide additional structural support for both the inner and outer coaxial ceramic tubes associated with the primary source gas material and evolved gas containment. In both cases the ceramic containment may be supported by a metal structure on the inside and outside of the coaxial source; radially inside, providing support to the inner ceramic containment wall and radially outside providing support to the outer ceramic containment wall. In the illustrated preferred embodiment, the apertures 14a in the inner ceramic containment tube 14 are aligned with matching apertures 28a in the accelerator tube 28.

Precise design of such reinforcing metal structures depends on the details of the design, however it is preferred to incorporate the metal support structures such that they impose pre-stressed compressional, or radially inwardly directed, tension on the outer surfaces of the ceramic tubes 14 and 16, i.e., in the radial direction opposing the force that the expanding gas applies. Methods to accomplish this may include fabrication of the ceramic in contact with an enclosing tubular metal support structure in the case of the outer tube 16, as well as using temperature expansion and contraction of such metal support structure through heating or cooling to created pre-compression coaxial engagement of the cylindrical ceramic and metal support structure.

The present invention is described herein by reference to certain preferred embodiments. However it is understood that various modifications and variations may be made by one of ordinary skill in the art without departing from the present invention. Accordingly, the scope of the present invention is defined by the following claims.

1. A solid-state pulsed power plasma jet injector for producing a plasma jet, comprising:
a gas source cartridge including an inner electrically nonconductive containment tube and an outer electrically nonconductive containment tube, said inner tube having a plurality of perforations therein, a pair of spaced, electrically conductive end ring electrodes positioned between said inner and outer containment tubes so as locate said containment tubes in a coaxial configuration with respect to one another, said containment tubes and said end ring electrodes defining a closed annular volume suitable for containing a solid gas source material in said annular volume;
a solid gas source material contained in said annular volume and operable to release a desired gas upon discharge of an electrical current through said solid gas source material;
an electrical cartridge driver including an electrical power supply connected to said end ring electrodes and operable to selectively discharge an electrical current through said solid gas source material to produce a gas;
a tubular accelerator extending through said inner containment tube of said gas source cartridge, said accelerator including an electrically conductive outer accelerator tube having a central longitudinal axis and an electrically conductive inner electrode rod extending coaxially therein along said axis of said accelerator tube, said outer accelerator tube being sized in outer diameter to correspond with the inner diameter of said inner cartridge tube, and said outer accelerator tube having a plurality of perforations aligned with said perforations in said inner containment tube of said gas source cartridge; and
an electrical accelerator driver having an electrical power supply connected to said accelerator tube and said inner accelerator electrode rod, said accelerator driver being operable to ionize and form a plasma from a gas formed in said gas cartridge and introduced into said accelerator tube through said perforations in said inner containment tube and said outer accelerator tube, and to accelerate said plasma to form a high velocity plasma jet.

2. The injector defined in claim 1 wherein said perforations in said inner containment tube and in said outer accelerator tube are distributed symmetrically around said tubes so as to result in azimuthally symmetrical introduction of said gas into said accelerator tube from said gas source cartridge.

3. The injector defined in claim 2 wherein said solid gas source material includes a metal hydride.

4. The injector defined in claim 3 wherein said solid gas source material consists essentially of a mixture of granular titanium hydride and fullerene.

5. The injector defined in claim 4 wherein said solid gas source material includes grains of granular titanium hydride coated with fullerene.

6. The injector defined in claim 5 wherein said grains of granular titanium hydride are substantially spherical.

7. The injector defined in claim 2 wherein said nonconductive inner and outer containment tubes of said gas source cartridge are formed of a ceramic material.

8. The injector defined in claim 1 further comprising an electrical pre-ionizer driver operable to pre-ionize said gas upon introduction into said tubular accelerator and prior to actuation of said electrical accelerator driver.

9. A solid-state pulsed power impurity plasma jet injector for mitigation of disruptions in a magnetically confined target plasma, comprising:
a gas source cartridge including an inner electrically nonconductive containment tube and an outer electrically nonconductive containment tube, said inner containment tube having a plurality of perforations therethrough, a pair of spaced electrically conductive end ring electrodes positioned between said inner and outer containment tubes so as locate said inner and outer tubes in a coaxial configuration, said inner and outer containment tubes and said end ring electrodes defining an annular volume suitable for containing a solid gas source material;
a solid gas source material contained in said annular volume and operable to release a desired gas upon discharge of an electrical current through said solid gas source material; and
a tubular accelerator passing through said inner containment tube of said gas source cartridge, said accelerator including an electrically conductive outer accelerator tube having a central longitudinal axis, an electrically conductive inner electrode rod extending coaxially along said longitudinal axis of said accelerator tube, said outer accelerator tube being sized in outer diameter to correspond with the inner diameter of said inner cartridge tube, and said outer accelerator tube having a plurality of perforations aligned with said perforations in said inner containment tube of said gas source cartridge;
said accelerator being operable to receive a plasma impurity gas introduced into said accelerator tube from said gas source cartridge and to ionize said impurity gas to form an impurity plasma, and to accelerate and inject said impurity plasma into a magnetically confined target plasma.

10. The injector defined in claim 9 wherein said perforations in said inner containment tube and in said outer accelerator tube are distributed symmetrically around said tubes so as to result in azimuthally symmetrical introduction of said gas into said accelerator tube from said gas source cartridge.

11. The injector defined in claim 10 wherein where said solid gas source material comprises a mixture of granular titanium hydride and fullerene

12. The injector defined in claim 11 wherein said solid gas source material comprises grains of granular titanium hydride coated with fullerene.

13. The plasma jet injector defined in claim 9 further comprising an electrical pre-ionizer driver and an electrical accelerator driver;
said pre-ionizer driver being connected to said accelerator and being operable to pre-ionize gas introduced into said accelerator tube from said gas cartridge; and
said electrical accelerator driver being connected to said electrically conductive outer accelerator tube and said electrically conductive inner electrode rod and being operable to further ionize said gas and to form a plasma, and to accelerate and emit said plasma as a plasma jet from said plasma jet injector.

14. A method for generating and injecting plasma jet into a magnetically confined target plasma, comprising the steps of:
producing a injection gas by application of an electrical current to a solid-state gas source material including a metal hydride;
introducing said injection gas into a accelerator tube through azimuthally symmetrical perforations in said tube;
applying an electrical current to said accelerator tube to ionize said injection gas and form an injection plasma; and
accelerating and injecting said injection plasma into a magnetically confined target plasma.

15. The method defined in claim 14 wherein said injection gas is produced by applying an electrical current to a solid mixture of a metal hydride and fullerene.

16. The method defined in claim 15 wherein said metal hydride is titanium hydride.

17. A method for mitigating a disruption in a magnetically confined target plasma, comprising the steps of:
producing an impurity gas by electrical resistive heating of a solid mixture of a metal hydride and fullerene to form a gaseous mixture of hydrogen and fullerene;
radially injecting said impurity gas into a an accelerator tube through a plurality of azimuthally symmetrical perforations formed in said accelerator tube;
partially ionizing said impurity gas by passage of an electrical current through said impurity gas to form an impurity plasma;
accelerating said impurity plasma axially along said accelerator tube; and
injecting said impurity plasma into a magnetically confined target plasma.

18. The method defined in claim 17 wherein said impurity gas is produced by electrical resistive heating of a solid mixture of titanium hydride and fullerene to form a gaseous mixture of hydrogen and fullerene.

19. The method defined in claim 18 wherein said impurity gas is produced by electrical resistive heating of granular titanium hydride coated with fullerene.

20. The method defined in claim 17 wherein the step of partially ionizing said impurity as includes the steps of pre-ionizing said impurity gas by use of an ultraviolet flashover radiation source, followed by the step of further ionizing said impurity gas by application of a an accelerator driver current to said accelerator tube.
